(19) United States
(12) Patent Application Publication
(10) Pub. No.: US 2008/0309903 A1
(43) Pub. Date: Dec. 18, 2008

(54) EXPOSURE APPARATUS, METHOD OF MANUFACTURING DEVICE, METHOD APPLIED TO EXPOSURE APPARATUS AND COMPUTER-READABLE MEDIUM

(75) Inventor: Osamu Morimoto, Utsunomiya-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/033,956

(22) Filed: Feb. 20, 2008

(30) Foreign Application Priority Data
Feb. 22, 2007 (JP) 2007-042677

(51) Int. Cl. G03B 27/42

(52) U.S. Cl. 355/53

(57) ABSTRACT

An exposure apparatus comprises: a controller configured to control a position of a stage and operation of a detector; and a computer terminal connected to the controller; wherein the controller is configured to: (i) cause the detector to perform position detection of alignment marks under each of a plurality of position detection conditions, and calculate an index of accuracy of the position detection based on an output from the detector associated with the position detection, with respect to each of the plurality of position detection conditions; and (ii) cause the computer terminal to provide a display concerning the index calculated with respect to each of the plurality of position detection conditions, and receive a instruction for selecting a plurality of candidate conditions from among the plurality of displayed position detection conditions via the computer terminal.

### BACKGROUND OF THE INVENTION

1. Field of the Invention

The present invention relates to determination of a condition for detecting the positions of alignment marks in an exposure apparatus.

2. Description of the Related Art

As circuit patterns become finer, there is a demand that reduced projection exposure apparatuses used in manufacturing semiconductor devices should align a reticle with a wafer more accurately during transfer of a pattern formed on the reticle onto the wafer.

Global alignment is widely used as a method for aligning a reticle with a wafer. In global alignment, the amounts of displacements of the positions (XY positions) of alignment marks formed on a number of shot regions to be exposed on a wafer from design values are detected. Regularity of an array of shot regions is obtained from the amounts of displacements, and thereby each shot region is aligned. Alignment detection is not performed on every shot region to be exposed in global alignment. Instead, alignment detection is performed only on a limited number of sample shot regions. This can improve the throughput of the exposure apparatus.

There are a number of methods for detecting the positions of alignment marks. One method is to detect the positions of alignment marks based on an image of the alignment marks on the substrate provided by a microscope. Another method is to detect the positions of alignment marks by measuring the phase of an interference signal produced by interference of light diffracted by diffraction gratings formed on the substrate as alignment marks.

In global alignment, process conditions of a wafer to be aligned can affect the performance of detection of alignment marks because of introduction of a special semiconductor manufacturing technique such as a CMP process. In such a case, position detection conditions must be changed according to the process conditions.

The position detection conditions include a property of illumination light (alignment illumination light) for observing alignment marks, the positions and shapes of the stop of a microscope and of other optical elements, and the shapes of marks selected from among multiple marks formed beforehand on a wafer. The position detection conditions also include signal processing algorithm (e.g. an image processing algorithm) for marks and the number and placements of sample shot regions in the global alignment. The number and placements of the sample shot regions should be appropriately chosen according to process conditions in order to balance improvement of throughput against improvement of the accuracy of alignment.

The present applicant have proposed methods for optimizing position detection conditions, in which alignment detection is performed while automatically changing from one position detection condition to another, and an index of appropriateness is calculated from the results of the alignment detection. The term “appropriateness” indicates that a condition is such that the accuracy of alignment is within a required specification.

For example, in a technique disclosed in Japanese Patent Application Laid-Open No. 2004-111860, global alignment detection is performed while automatically changing from one position detection condition (signal processing algorithm) to another, and an index (residual error) of appropriateness of each signal processing algorithm is calculated. Then, the signal processing algorithm that provides the smallest residual error is chosen as an appropriate position detection condition.

In Japanese Patent Application Laid-Open No. 5-335212, global alignment detection is performed multiple times while automatically changing from one position detection condition (such as the shape of marks) to another. Then an index (feature amount) of appropriateness relating to variations in detected values is calculated for each condition such as the shape of marks. The shape of marks that provides the smallest feature amount is chosen as an appropriate position detection condition.

In Japanese Patent Application No. 2001-093807, global alignment detection and focus detection are performed while automatically changing a position detection condition (the shapes of marks selected from multiple marks). Then, an index (change in focus property) of appropriateness of each mark shape is calculated and the shape of each mark that provides the smallest change in focus property is chosen as an appropriate position detection condition.

The techniques disclosed in Japanese Patent Application Laid-Open Nos. 2004-111860, 5-335212, and 2001-093807 calculate an index of appropriateness of each position detection condition while automatically changing from one position detection condition to another as described above. The result of actual exposure process (for example the accuracy of overlay between a pattern already formed on a wafer and a pattern of a reticle transferred onto the wafer) can significantly differ from the calculated index of appropriateness. In other words, the calculated index of appropriateness can lose touch with the result of actual exposure process. In that case, an appropriate position detection condition might not be calculated by using such a calculated index of appropriateness. Consequently, an overlay error in an exposure process might not be reduced.

### SUMMARY OF THE INVENTION

The present invention provides, for example, improvement with respect to determination of a condition for detecting the positions of alignment marks in an exposure apparatus.

According to the first aspect of the present invention, there is provided an exposure apparatus for exposing a substrate to radiant energy, the apparatus having a stage configured to hold the substrate and to be moved, and a detector configured to detect positions of alignment marks formed on the substrate held by the stage, exposing the substrate to radiant energy in accordance with the positions detected by the detector, and determining a position detection condition for the detector based on an alignment error of the exposed substrate, the apparatus comprising: a controller configured to control a position of the stage and operation of the detector; and a computer terminal connected to the controller; wherein the controller is configured to: (i) cause the detector to perform position detection of the alignment marks under each of a plurality of position detection conditions, and calculate an index of accuracy of the position detection based on an output from the detector associated with the position detection, with respect to each of the plurality of position detection conditions; and (ii) cause the computer terminal to provide a display concerning the index calculated with respect to each of the plurality of position detection conditions, and receive a instruction for selecting a plurality of candidate conditions from among the plurality of displayed position detection conditions via the computer terminal.

According to the second aspect of the present invention, there is provided a method of manufacturing a device, the method comprising steps of: exposing a substrate to radiant energy using an above-described exposure apparatus; developing the exposed substrate; and processing the developed substrate to manufacture the device.

According to the third aspect of the present invention, there is provided a method applied to an exposure apparatus for exposing a substrate to radiant energy, the apparatus having a stage configured to hold the substrate and to be moved, a detector configured to detect positions of alignment marks formed on the substrate held by the stage, a controller configured to control a position of the stage and operation of the detector, and a computer terminal connected to the controller, and exposing the substrate to radiant energy in accordance with the positions detected by the detector, the method determining a position detection condition for the detector based on an alignment error of the exposed substrate, the method comprising steps executed by the controller, the steps comprising: causing the detector to perform position detection of the alignment marks under each of a plurality of position detection conditions; calculating an index of accuracy of the position detection based on an output from the detector associated with the position detection, with respect to each of the plurality of position detection conditions; causing the computer terminal to provide a display concerning the index calculated with respect to each of the plurality of position detection conditions; and receiving a instruction for selecting a plurality of candidate conditions from among the plurality of displayed position detection conditions via the computer terminal.

According to the fourth aspect of the present invention, there is provided a computer-readable medium which stores a program for causing a computer to execute an above-described method.

According to the present invention, it is possible to improve with respect to determination of a condition for detecting the positions of alignment marks.

Further features of the present invention will become apparent from the following description of exemplary embodiments with reference to the attached drawings.

### BRIEF DESCRIPTION OF THE DRAWINGS

FIG. 1 is a diagram showing a configuration of an exposure apparatus according to an embodiment of the present invention;

FIG. 2 is a flowchart showing a flow of process performed by the exposure apparatus for providing an appropriate position detection condition;

FIG. 3 is a flowchart showing a flow of process for identifying candidate parameter information;

FIG. 4 is a diagram showing candidate parameter information;

FIG. 5 is a diagram showing candidate layout information;

FIG. 6 is a diagram showing candidate layout information (a variation);

FIG. 7 is a diagram showing candidate condition information;

FIG. 8 is a diagram showing results of alignment detection;

FIG. 9 is a diagram showing a setting instruction; and

FIG. 10 is a flowchart showing an overview of a process for manufacturing a semiconductor device.

### DESCRIPTION OF THE EMBODIMENTS

The term “appropriateness” as used herein means that a condition is such that the accuracy of alignment is within a required specification.

The present invention relates to an apparatus requiring a precise alignment unit. For example, the present invention relates to a reduced projection exposure apparatus that accurately aligns multiple objects with each other to exposes a semiconductor substrate to radiant energy by projecting an electronic circuit pattern onto the semiconductor substrate.

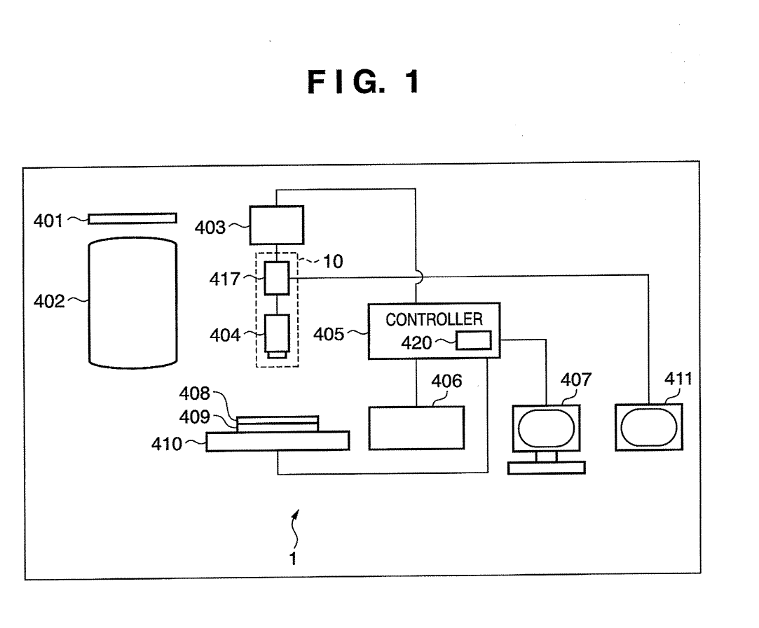

A general configuration of an exposure apparatus 1 according to an embodiment of the present invention will be described with reference to FIG. 1. FIG. 1 shows a configuration of an exposure apparatus 1 according to an embodiment of the present invention.

The exposure apparatus 1 has the function of performing off-axis wafer alignment. The exposure apparatus 1 comprises a projecting optical system 402, an image processing apparatus 403, a pre-alignment apparatus 406, a computer terminal 407, a wafer stage 410, and a wafer chuck 409. The exposure apparatus 1 also includes an alignment detection system (detector) 10, a monitor 411, and a controller (selection unit, controller, determination unit) 405.

The projecting optical system 402 is disposed downstream of an optical axis (not shown) with respect to a retile (mask) 401.

The image processing apparatus 403 performs various kinds of image processing on input image signals and stores the image signals and results of arithmetic processing.

The pre-alignment apparatus 406 roughly adjusts (pre-aligns) the orientation of a wafer (substrate) according to the wafer's fiducials (such as orientation flats) when the wafer is transferred from a wafer loader, not shown, to the alignment system.

The computer terminal 407 accepts a command input from a user.

The wafer stage 410 moves the coordinate position of a wafer 408 to be aligned in the horizontal and vertical directions. The wafer stage 410 thus positions the wafer 408.

The wafer chuck 409 is provided on the wafer stage 410 for holding the wafer 408.

The alignment detection system 10 is an off-axis observation optical system. The alignment detection system 10 includes a light source (not shown), a microscope 404, and a CCD camera 417. The microscope 404 is provided for magnifying an image of a pattern formed on a wafer 408 for observation. The CCD camera 417 converts an optical image of a pattern on a wafer 408 obtained through the microscope 404 into an electric signal and provides the electric signal to the image processing apparatus 403.

The monitor 411 displays an image captured by the CCD camera 417 in real time. This allows a user to directly check the image captured by the CCD camera 417 in real time.

The controller 405 controls the components of the exposure apparatus 1. The controller 405 includes a memory 420 and a CPU (not shown). The memory 420 functions as a buffer during processing by the CPU or stores information to be stored for a certain period of time.

Referring to FIG. 1, an overview of an operation of the exposure apparatus 1 will be provided below.

Alignment illumination light from the light source (not shown) in the alignment detection system 10 is applied to an alignment mark formed on a wafer 408. Light scattered from the alignment mark is received at the CCD camera 417 via the microscope 404 and is converted into an electric signal. The electric signal is provided to the image processing apparatus 403 and the monitor 411. The image processing apparatus 403 applies predetermined image computation processing to the electric signal it received and stores the processed image signal. The monitor 411 displays an image corresponding to the electric signal it received.

The wafer 408 is loaded into the exposure apparatus 1 during an exposure process. In response to this, the controller 405 provides control so that a position detecting process is performed. The alignment detection system 10 performs alignment detection in multiple sample shot regions selected from among multiple shot regions (target regions) on the wafer 408 under the control of the controller 405 on position detection conditions optimized in advance. That is, the alignment detection system 10 performs global alignment detection. The alignment detection system 10 provides the result of the global alignment detection to the image processing apparatus 403. The image processing apparatus 403 applies predetermined image processing to the result of alignment detection and provides the result of the image processing to the controller 405. The controller 405 calculates a drive control value for controlling the drive of the wafer stage 410 from the result of the global alignment detection as an alignment parameter for the wafer 408.

The controller 405 controls the drive of the wafer stage 410 according to the alignment parameter so that the reticle 401 and the wafer 408 are globally aligned with each other. As a result, the XY position of the wafer 408 is corrected. The reticle 401 is illuminated by an illumination optical system (not shown). The illumination light is diffracted by the pattern on the reticle 401 to form an image of the same pattern on the wafer 408 through projecting optical system 402. Thus, the pattern on the reticle 401 is transferred to the shot regions on the wafer 408.

Alignment parameters here are parameters for correcting the XY position of the wafer 408 by controlling the drive of wafer stage 410 based on the result of global alignment detection. The alignment parameters may be a wafer shift (X, Y), a wafer rotation angle, wafer orthogonality, wafer scaling (X, Y), a shot region rotation (X, Y), a shot region magnification (X, Y), a nonlinear error of a shot region array, and a nonlinear error of the shot region shape. The wafer shift (X, Y), wafer rotation angle, wafer orthogonality, and wafer scaling (X, Y) represent displacements of the wafer or arrangement errors of a shot region. The shot region rotation (X, Y) and shot region magnification (X, Y) represent a posture or shape error of a shot region.

According to the present invention, alignment detection on a wafer 408 described above is repeated to narrow down candidates for an appropriate position detection condition, which will be described later. Alignment parameters of each of the candidate position detection conditions narrowed down are calculated, the position of the wafer 408 is corrected by global alignment, and then the wafer 408 is exposed to radiant energy.

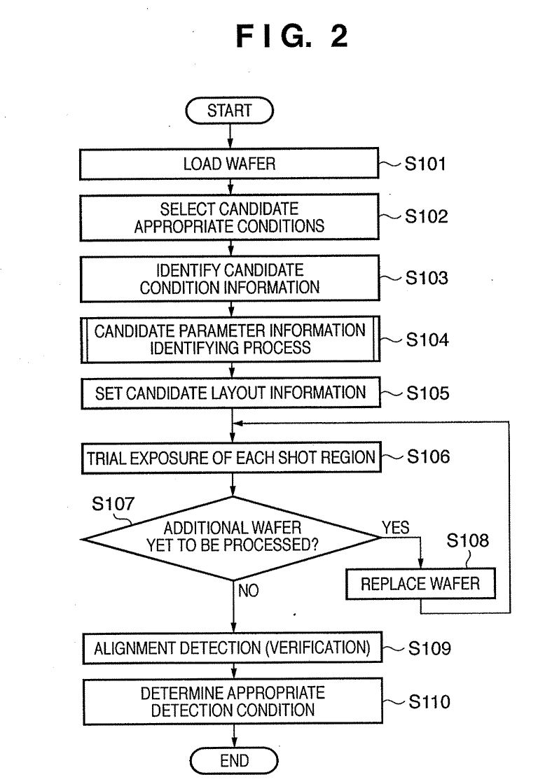

A flow of process performed by the exposure apparatus 1 for providing an appropriate position detection condition will be described with reference to FIG. 2. FIG. 2 is a flowchart illustrating a flow of process performed by the exposure apparatus 1 for providing an appropriate position detection condition.

In step S101, one wafer 408 is loaded on the wafer chuck 409 and the wafer stage 410. The wafer chuck 409 holds the wafer 408. With this performance, the wafer 408 is held on the wafer stage 410.

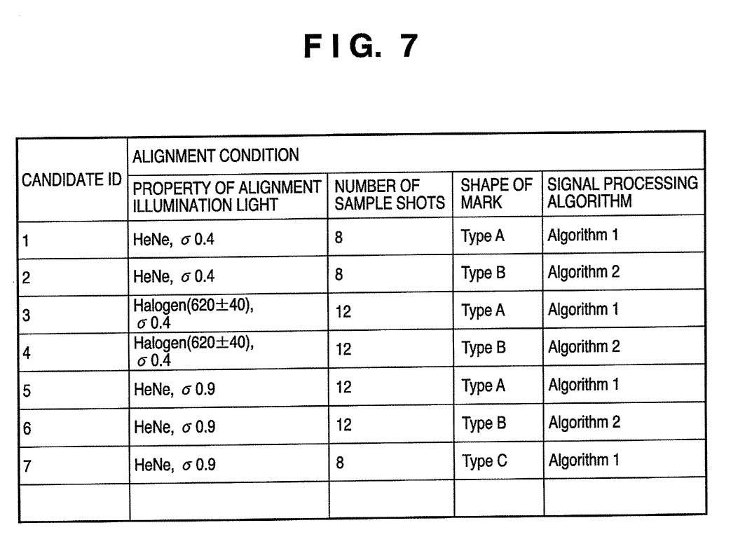

In step S102, the controller 405 controls the alignment detection system (detector) 10 to repeatedly perform global alignment detection while changing multiple position detection conditions. The image processing apparatus 403 calculates an index of the accuracy of alignment (hereinafter referred to as alignment index) based on the result of global alignment detection. The image processing apparatus 403 provides the alignment index to the controller 405. The controller 405 selects a predetermined number of candidate (seven candidates in FIG. 7) of appropriate position detection conditions (hereinafter referred to as candidate appropriate conditions) index from among multiple position detection conditions, in descending order of appropriateness.

Here, the position detection conditions include at least one of a property (illumination mode) of illumination light (alignment illumination light) used for observing alignment marks, a property of the optical system for detecting the positions of alignment marks, and the shape, number, and placement of the alignment marks. The property of the optical system for detecting the positions of alignment marks may be the position or shape of the stop of the microscope or other optical elements, for example. The position detection conditions include: a signal processing algorithm (for example an image processing algorithm) for an image signal obtained by imaging the alignment marks; and the number and placements of sample shot regions in global alignment. The alignment index may be the reproducibility of a result of alignment detection, the minimum correction residual, or an index of the quality of a signal waveform that appears when a mark (inspection mark) is detected.

It should be noted that the position detection conditions may be any conditions that can be set by a user for each exposure process and that change the result of alignment detection (such as accuracy, measurement reproducibility, or absolute error). The alignment index may be any index that represents the accuracy of alignment. The alignment index may be obtained by using a method described in any of Japanese Patent Application Laid-Open Nos. 2004-111860, 5-335212, and 2001-093807.

In step S103, the controller 405 identifies each element (hereinafter referred to as position detection condition element) which is contained in each position detection condition of the plurality of selected candidate appropriate conditions. The controller 405 obtains a value that identifies the ordinal rank of goodness of each position detection condition (hereinafter referred to as the candidate ID, meaning the ID identifying a candidate appropriate condition) based on the index of the position detection condition. The controller 405 identifies and stores information including the position detection conditions and the candidate IDs associated with the position detection conditions (hereinafter referred to as candidate condition information). The candidate condition information may be information including candidate IDs, properties of alignment illumination light, the number of sample shot regions, the shapes of marks (inspection marks), and signal processing algorithms associated with one another as shown in FIG. 7.

It should be noted that the candidate condition information may be provided from the controller 405 to the image processing apparatus 403 and stored in the image processing apparatus 403.

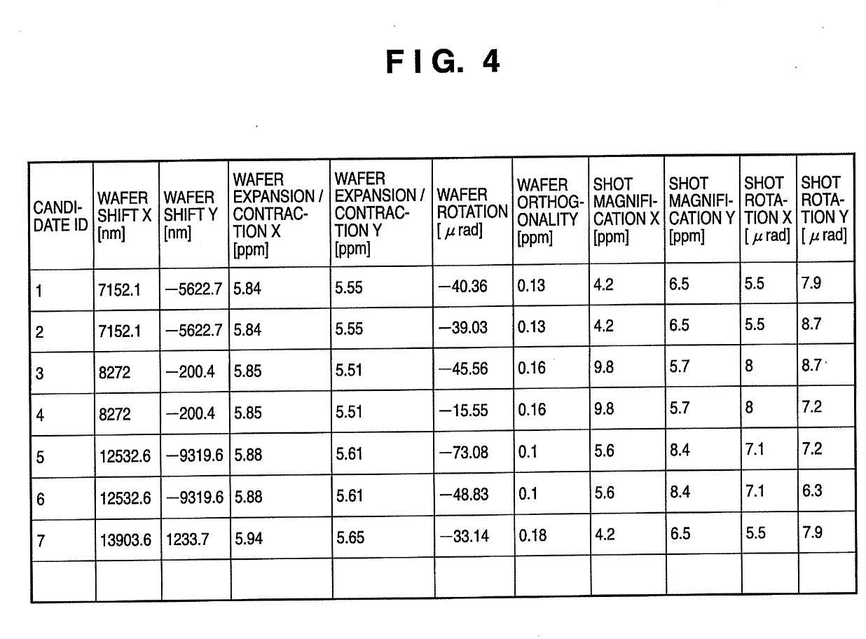

In step S104, the controller 405 performs a candidate parameter information identifying process. The candidate parameter information identifying process is a process for identifying information including a candidate ID and alignment parameters associated with the candidate ID (hereinafter referred to as candidate parameter information. See FIG. 4). The candidate parameter information identifying process will be detailed later.

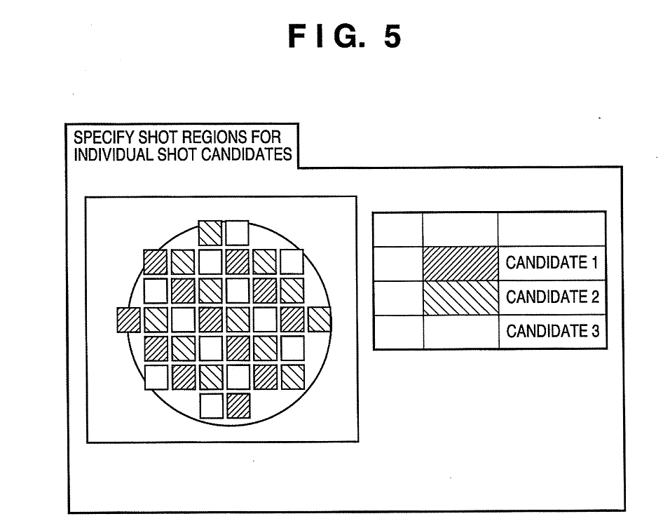

In step S105, a display prompting an operator to input a setting instruction is displayed on the display screen of the computer terminal 407 (See FIG. 5). The setting instruction is an instruction for setting information including a candidate ID and an exposure layout (layout position of each shot region) associated with each other (hereinafter referred to as candidate layout information). The user inputs the setting instruction through an input unit of the computer terminal 407.

It should be noted that the input unit includes a GUI (Graphical User Interface) shown in FIG. 5 in addition to a keyboard and a mouse. The association between a candidate ID and the position of a shot region (which may be information indicating the coordinates of the shot region or an ID indicating the position of the shot region) is input through the input unit. The GUI of the input unit allows the user to input multiple groups of shot regions and to specify the ID of a candidate position detection condition that the user desires to use for each group of shot regions.

The controller 405 receives the setting instruction from the computer terminal 407. The controller 405 generates candidate layout information (see FIG. 5) based on the setting instruction.

In step S106, the controller 405 causes the alignment detection system 10 to detect the position of the wafer 408, based on the candidate layout information, candidate parameter information, and candidate condition information. For example, the alignment detection system 10 detects the position of a first shot region using a first position detection condition associated with the first shot region. Similarly, the alignment detection system 10 detects a second shot region using a second position detection condition associated with the second shot region. In this way, the alignment detection system 10 detects the positions of individual shot regions using different position detection conditions for the individual shot regions. There are shot regions in different positions on the wafer 408 that are positioned based on the position of the wafer 408 detected on each of the two or more position detection conditions.

The controller 405 causes the wafer stage 410 to position the wafer 408 with respect to each shot region. Then, the controller 405 cause each shot region on the wafer 408 to be exposed on trial. As a result, a pattern of alignment marks formed on a reticle (not shown) for forming alignment marks is transferred onto the wafer 408 and latent images of the alignment marks (inspection marks) are formed on the wafer 408.

An example is considered here in which candidate layout information for one wafer as shown in FIG. 5 is referred to by the controller 405. In the example shown in FIG. 5, there are three candidate conditions, and narrow hatching shows a shot region set for candidate ID “1”, wide hatching shows a shot region set for candidate ID “2”, and no hatching shows a shot region set for candidate ID “3”. The controller 405 refers to the candidate layout information and candidate condition information to detect the position of the wafer 408 under a position detection condition such as a property of alignment illumination light “HeNe, σ0.4” (see FIG. 7) for the shot region set for candidate ID “1”. The controller 405 refers to the candidate layout information and candidate parameter information to identify an alignment parameter such as wafer shift X “7152.1” (see FIG. 4) for the shot region set for candidate ID “1”. The controller 405 controls the drive of the wafer stage 410 using the alignment parameter to correct (position or align) the position of the wafer 408. The controller 405 causes the wafer 408 to be exposed on trial. The controller 405 also performs control similar to the control described above for candidate IDs “2” and “3”.

Thus, because the controller 405 generates candidate layout information according to a setting instruction input into the computer terminal 407 as described above, position detection can be performed on multiple position detection conditions for one wafer. The wafer 408 positioned can be exposed on trial.

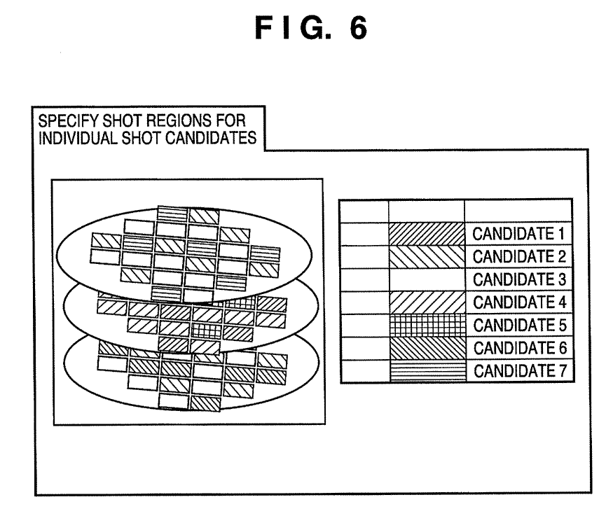

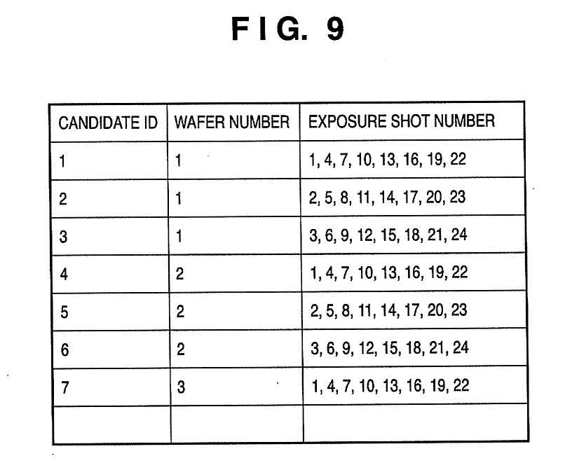

It should be noted that candidate layout information referred to by the controller 405 may be information in which multiple position detection conditions are assigned to multiple wafers as shown in FIG. 6. In that case, different candidate IDs can be specified for different wafers. Thus, because the trial exposure can be performed on more candidate conditions, a highly reliable result can be obtained, although the number of wafers subjected to trial exposure increases. The setting instruction input through the GUI shown in FIG. 5 or 6 can associate a candidate ID, a wafer number, and a set of shot region numbers with each other as shown in FIG. 9, for example.

In step S107, the controller 405 determines whether there is an additional wafer yet to be processed. If the controller 405 determines that there remains an additional wafer yet to be processed, the process proceeds to step S109; otherwise, the controller 405 advances the process to step S108.

For example, if the controller 405 refers to candidate layout information for one wafer as shown in FIG. 5, the controller 405 determines that there is not a wafer yet to be processed. For example, if the controller 405 refers to candidate layout information for multiple wafers as shown in FIG. 6, after one wafer is processed, the controller 405 determines that there is a wafer yet to be processed.

In step S108, the wafer chuck 409 releases the wafer 408. The wafer 408 is unloaded from the wafer chuck 409 and the wafer stage 410. Then, another wafer 408 is loaded on the wafer chuck 409 and the wafer stage 410. The wafer chuck 409 holds the wafer 408. With this performance, the wafer 408 is fixed on the wafer stage 410. Then the controller 405 advances the process to step S106.

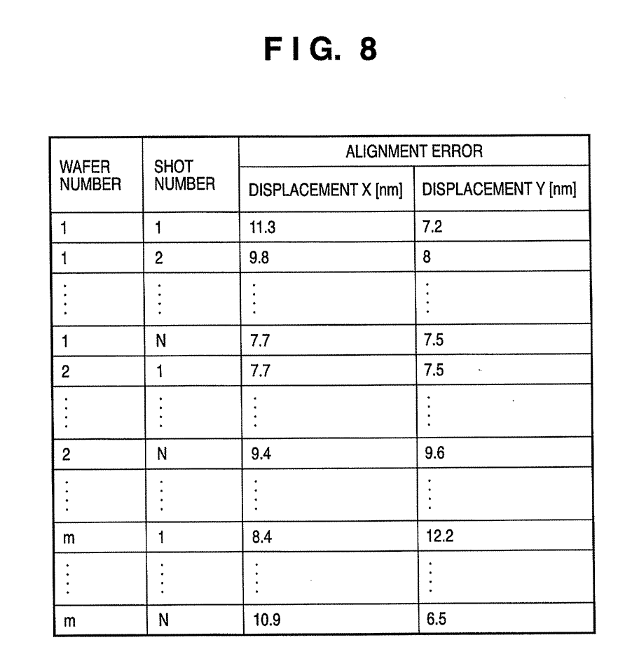

In step S109 (second detection step), the controller 405 controls the alignment detection system (detector) 10 so that alignment marks on the wafer exposed on trial are subjected to alignment detection on the specified position detection condition. Thus, the result of the alignment detection (see FIG. 8) in each shot region associated with each position detection condition can be obtained. For example, the controller 405 obtains information about an alignment error in each shot region.

It should be noted that the controller 405 may cause an image of a wafer exposed on trial to be developed and cause the alignment detection system (detector) 10 to perform alignment detection on the developed image of the wafer. Alternatively, the controller 405 may cause the alignment detection system 10 to perform alignment detection on a wafer exposed on trial without developing an latent image formed on the wafer by trial exposure. If a detection system (detector) that enables observation of a latent image is used as the alignment detection system 10 of the exposure apparatus 1, the alignment detection can be performed without developing a latent image of a wafer exposed on trial, and accordingly the processing time can be reduced. Instead of the alignment detection system 10, an alignment detection apparatus (detector, not shown) external to the exposure apparatus 1 may be used to perform the alignment detection.

In step S110 (determination step), the controller (determination unit) 405 calculates an index of appropriateness with regard to variations in alignment accuracy based on the result of alignment of each shot region (see FIG. 8) and the candidate layout information (See FIG. 5). The controller 405 then determines appropriate candidate IDs (in other words, the position detection conditions indicated by the candidate IDs) to be used for detecting the position of the wafer 408 in the exposure process. With this performance, the likelihood of appropriateness of the alignment index calculated in step S102 can be verified.

For example, the controller 405 classifies alignment errors for each shot region by candidate ID based on the candidate layout information. The controller 405 calculates variation in alignment error (3σ, where σ is the standard deviation) of each group classified by candidate ID as an index of appropriateness. The controller 405 determines the candidate ID whose index of appropriateness (variation in alignment error) is the smallest as an appropriate candidate ID.

It should be noted that the index of appropriateness may be a variation in a magnification error of a shot arrangement or orthogonality error, instead of a variation in alignment error.

The controller 405 determines an appropriate position detection condition based on the determined appropriate candidate ID and candidate condition information. That is, the controller 405 determines the position detection condition associated with the appropriate candidate ID in the candidate condition information as the appropriate position detection condition.

It should be noted that an alignment detection apparatus external to the exposure apparatus 1 may calculate the index of appropriateness. In that case, the controller 405 provides the result of alignment detection in each shot region (see FIG. 8) and the candidate layout information (see FIG. 5) to the external alignment detection apparatus through a network or a storage medium. Furthermore, the alignment detection apparatus external to the exposure apparatus 1 may determine the appropriate position detection condition. In that case, the controller 405 provides the candidate condition information (see FIG. 7) to the external alignment detection apparatus through a network or a storage medium. If the information is provided through a network, the exposure apparatus 1 should be connected to the alignment detection apparatus through the network and both apparatuses should have communication facilities. Alternatively, if the information is provided through a storage medium, the exposure apparatus 1 should include an interface for writing information on the storage medium and the alignment detection apparatus should include an interface for reading information from the storage medium.

It should be noted that the candidate parameter information identifying process may be performed in the process of selecting candidate appropriate conditions in step S102. In that case, the process in step S104 can be omitted and accordingly the entire processing time can be reduced.

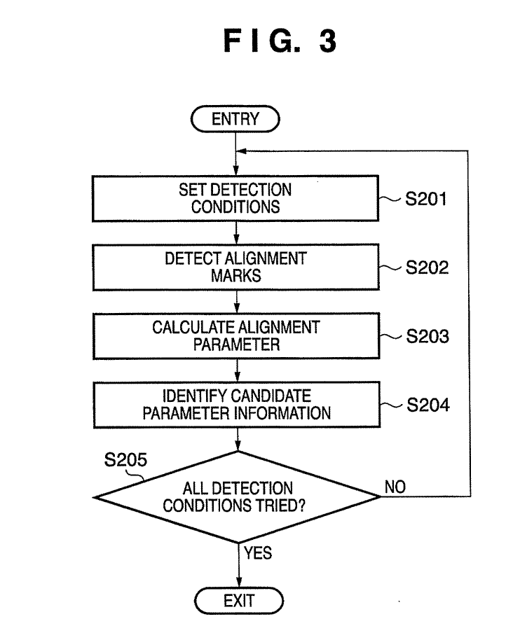

The candidate parameter information identifying process will be described next with reference to FIG. 3. FIG. 3 is a flowchart illustrating a flow of the candidate parameter information identifying process.

In step S201, the controller 405 selects and sets a position detection condition that has not yet been selected in the candidate condition information.

For example, the controller 405 sets the position detection conditions with candidate ID “1” shown in FIG. 7 as the first position detection condition. The first position detection condition includes alignment illumination light properties, “Light source: HeNe, Stop: σ0.4”, the number of sample shot regions, “8”, shape of mark, “Type A”, and a signal processing algorithm, “Algorithm 1”.

In step S202, the controller 405 controls each component according to the set position detection condition. The controller 405 controls the alignment detection system 10 so as to detect alignment marks in the shot regions on a wafer 408 with global alignment detection. The alignment detection system 10 outputs the result of the global alignment detection to the controller 405.

In step S203, the controller 405 calculates a drive control value for controlling the drive of the wafer stage 410 as an alignment parameter based on the result of the global alignment detection.

In step S204, the controller 405 identifies and stores information including the alignment parameter and the candidate ID associated with the alignment parameter (hereinafter the information is referred to as candidate parameter information) (See FIG. 4).

In step S205, the controller 405 determines whether the candidate parameter information has been identified for all position detection conditions of the candidate appropriate conditions. If so, the controller 405 will ends the process; otherwise the controller 405 advance the process to step S201.

Thus, as a result of the candidate parameter information identifying process, candidate parameter information for all position detection conditions included in the candidate condition information is identified and stored.

As described above, because not only the index is calculated from the result of alignment detection but also the likelihood of appropriateness of the index is verified based on the result of alignment detection after trial exposure, an appropriate position detection condition can be obtained. Consequently, alignment errors (positioning errors) in the exposure process can be reduced.

Furthermore, trial exposure of one wafer can be performed on multiple position detection conditions. Thus, trials can be performed on a sufficient number of position detection conditions using a small number of wafers for trial exposure to obtain an appropriate position detection conditions. Consequently, alignment errors (positioning errors) in the exposure process can be reduced.

It should be noted that the controller 405 may generate candidate layout information (see FIG. 5) in step S105 in FIG. 2 upon end of the candidate parameter information identifying process, instead of in response to a setting instruction. In that case, the controller 405 may determine correspondence between a candidate ID and an exposure layout by using a random number. By randomly associating candidate IDs with exposure layouts in this way, the influence of systematic errors that depend on layout positions on a wafer can be minimized. Systematic errors that depend on layout positions on a wafer include local distortions of the wafer, errors in individual scan directions of a substrate, and errors in individual step directions.

It should be also noted that, if appropriate conditions have been empirically narrowed down to a number of candidates beforehand, step S102 in FIG. 2 can be omitted. By omitting step S102, processing time for obtaining appropriate position detection conditions can be reduced.

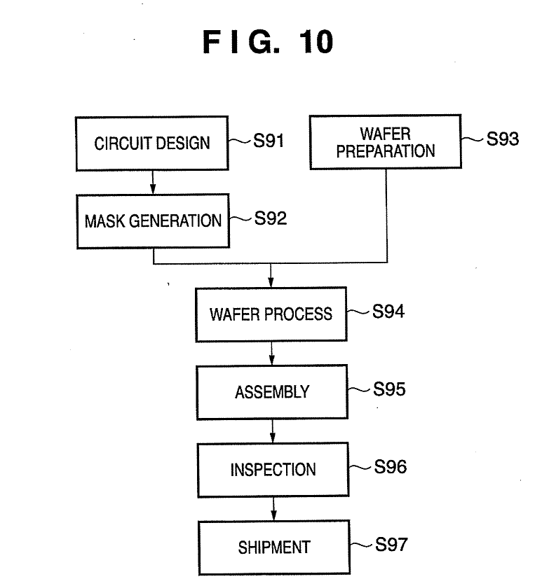

A device manufacturing process (manufacturing method) using an exemplary exposure apparatus will be described below with reference to FIG. 10. FIG. 10 is a flowchart illustrating an overall process for manufacturing an exemplary semiconductor device.

In step S91 (circuit design), the circuitry of the semiconductor device is designed.

In step S92 (mask generation), a mask (also called reticle) is generated based on the designed circuit pattern.

On the other hand, in step S93 (wafer preparation), a wafer (also referred to as substrate) is prepared from a material such as silicon.

In step S94 (wafer process), called the pre-process, the mask and the wafer are used to form actual circuits with a lithography technique on the wafer on the exposure apparatus described above.

In step S95 (assembly), called the post-process, the wafer generated in step S94 is used to make semiconductor chips. This step includes fabrication processes such as an assembly process (dicing and bonding) and a packaging (chip packaging) process.

In step S96 (inspection), tests such as operation check tests and durability tests of the semiconductor devices fabricated in step S95 are performed. After undergoing these processes, the semiconductor device is completed and is then shipped in step S97.

The wafer process in step S94 includes the following steps: an oxidation step of oxidizing the surface of the wafer, a CVD step of depositing an insulating film on the surface of the wafer, an electrode formation step of forming electrodes on the wafer by vapor deposition, and an ion implantation step of implanting ions in the wafer. The wafer process also includes a resist process of applying a photoresist on the wafer, an exposure step (exposure process) of exposing the wafer to which the resist was applied to radiant energy through a pattern on the mask in the exposure apparatus described above to form a latent pattern on the resist, a development step (development process) of developing the pattern image on the wafer exposed in the exposure step, an etching step of etching off the portions other than the latent pattern developed in the development step, and a resist removal step of removing the resist used in the etching that is no longer needed. These steps are repeated to form layers of circuit patterns on the wafer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-042677, filed Feb. 22, 2007, which is hereby incorporated by reference herein in its entirety.

What is claimed is:

1. An exposure apparatus for exposing a substrate to radiant energy, the apparatus having a stage configured to hold the substrate and to be moved, and a detector configured to detect positions of alignment marks formed on the substrate held by the stage, exposing the substrate to radiant energy in accordance with the positions detected by the detector, and determining a position detection condition for the detector based on an alignment error of the exposed substrate, the apparatus comprising:
a controller configured to control a position of the stage and operation of the detector; and
a computer terminal connected to the controller;
wherein the controller is configured to:
(i) cause the detector to perform position detection of the alignment marks under each of a plurality of position detection conditions, and calculate an index of accuracy of the position detection based on an output from the detector associated with the position detection, with respect to each of the plurality of position detection conditions; and
(ii) cause the computer terminal to provide a display concerning the index calculated with respect to each of the plurality of position detection conditions, and receive a instruction for selecting a plurality of candidate conditions from among the plurality of displayed position detection conditions via the computer terminal.

2. An apparatus according to claim 1, wherein
the controller is further configured to:
(iii) cause the detector to detect positions of a plurality of alignment marks formed on the substrate and control the position of the stage based on the detected positions of the plurality of alignment marks so as to form a plurality of inspection marks on the substrate held on the stage by exposing the substrate to radiant energy, with respect to each of the plurality of candidate conditions; and
(iv) select a position detection condition for alignment marks formed on the substrate from among the plurality of candidate conditions based on a variation of errors in alignment of the plurality of inspection marks formed with respect to each of the plurality of candidate conditions.

3. An apparatus according to claim 1, wherein
the controller is further configured to control, at the step (iii), the position of the stage and operation of the detector so that an inspection mark is formed in each of a first plurality of shot regions on the substrate under a first condition among the plurality of candidate conditions and an inspection mark is formed in each of a second plurality of shot regions on the substrate under a second condition among the plurality of candidate conditions.

4. An apparatus according to claim 2, wherein
the controller is further configured to receive correspondence between the first condition and the first plurality of shot regions and correspondence between the second condition and the second plurality of shot regions via the computer terminal.

5. An apparatus according to claim 1, wherein
the position detection conditions for the detector includes at least one of a property of illumination light for the alignment mark, a property of an optical system for detecting a positions of the alignment mark, a shape of the alignment mark, number of the alignment marks, and arrangement of the alignment marks, and a signal processing algorithm for a signal obtained by capturing an image of the alignment mark.

6. An apparatus according to claim 2, wherein
the controller is further configured to calculate, at the step (iv), the variation of errors.

7. An apparatus according to claim 2, wherein
the controller is further configured to receive, at the step (iv), the variation of errors from an external device.

8. A method of manufacturing a device, the method comprising steps of:
exposing a substrate to radiant energy using an exposure apparatus according to claim 1;
developing the exposed substrate; and
processing the developed substrate to manufacture the device.

9. A method applied to an exposure apparatus for exposing a substrate to radiant energy, the apparatus having a stage configured to hold the substrate and to be moved, a detector configured to detect positions of alignment marks formed on the substrate held by the stage, a controller configured to control a position of the stage and operation of the detector, and a computer terminal connected to the controller, and exposing the substrate to radiant energy in accordance with the positions detected by the detector, the method determining a position detection condition for the detector based on an alignment error of the exposed substrate, the method comprising steps executed by the controller, the steps comprising:
causing the detector to perform position detection of the alignment marks under each of a plurality of position detection conditions;
calculating an index of accuracy of the position detection based on an output from the detector associated with the position detection, with respect to each of the plurality of position detection conditions;
causing the computer terminal to provide a display concerning the index calculated with respect to each of the plurality of position detection conditions; and
receiving a instruction for selecting a plurality of candidate conditions from among the plurality of displayed position detection conditions via the computer terminal.

10. A computer-readable medium which stores a program for causing a computer to execute each steps of a method according to claim 9.
